(19) United States
(12) Patent Application Publication
(10) Pub. No.: US 2025/0060382 A1
(43) Pub. Date: Feb. 20, 2025

(54) TRANSFER DEVICE, METHOD, AND USE OF A TRANSFER DEVICE FOR TRANSFERRING AT LEAST ONE FUNCTIONAL ELEMENT INTO A PROCESS CHAMBER

(71) Applicant: TT INNOVATION AG, Zug (CH)

(72) Inventors: Marc Tondera, Riehen (CN); Tobias SCHNEIDLER, Diepfingen (CH); Julia CARLI, Basel (CH); Mathieu MÜLLER, Sierentz (FR); Philipp LEUENBERGER, Basel (CH); Christophe RETHORET, Issenheim (FR); Mike ZELLER, Wahlen (CH)

(73) Assignee: TT INNOVATION AG, Zug (CH)

(21) Appl. No.: 18/728,143

(22) PCT Filed: Jan. 11, 2023
(86) PCT No.: PCT/EP2023/050556

§ 371 Date: Jul. 11, 2024

(30) Foreign Application Priority Data
Jan. 12, 2022 (DE) 10 2022 100 678.6

(51) Int. Cl. G01N 35/02; B01L 1/02; G01N 35/04; G01N 35/10

(52) U.S. Cl. CPC G01N 35/02; B01L 1/025; G01N 35/10; G01N 35/1072; G01N 2035/0493; G01N 2035/1027

(57) ABSTRACT

A transfer device (2) and a method for transferring at least one functional element (3) into a process chamber (4) are provided, wherein the at least one functional element (3) is arranged interchangeably on an element carrier (5) and the element carrier (5) is transferable from a starting position (6) into an end or working position (7), wherein, in the end or working position (7), the at least one functional element (3) is arranged partly in the process chamber (4) and partly outside the process chamber (4). The invention is therefore particularly suitable for aseptic processes in the pharmaceutical industry, but is not limited to this sphere.

### CROSS-REFERENCE TO RELATED APPLICATIONS

This application is a 371 National Phase of PCT/EP2023/050556, filed Jan. 11, 2023, which claims priority to German Patent Application No. DE 10 2022 100 678.6, filed Jan. 12, 2022, both of which are incorporated herein by reference as if fully set forth.

### TECHNICAL FIELD

The invention relates to a transfer device for transferring at least one functional element into a process chamber, wherein the at least one functional element is arranged interchangeably on an element carrier and the element carrier is transferable from a starting position into an end position, for example a working position or an intermediate position on the way to a working position.

The invention further relates to a method for transferring at least one functional element to a transfer opening for transferring same to a process chamber, wherein the functional element is transferred by the transfer device to the transfer opening and the functional element is then received in the process chamber from a transport device.

For example, the transport device may be fastened to the process chamber, in particular to a bottom or a partition.

The invention further relates to the use of a transfer device for transferring at least one functional element into a process chamber.

### BACKGROUND

In many industrial sectors, in particular in the pharmaceutical industry, manual activities continue to be necessary despite a multiplicity of automated processes. For example, components of aseptic filling devices are thus transferred manually to a process chamber of a containment, clean room or an isolator and then assembled. Manual interventions constitute a considerable risk since, firstly, the likelihood of product contamination may be increased and, secondly, the health of employees, especially when working with toxic components, is put at risk. Manual work in process chambers is also time-consuming and costly from the point of view of procedural economy.

### SUMMARY

It is therefore the object of the invention to improve transfers and work in process chambers.

To achieve the stated object, one or more of the features disclosed herein are provided according to the invention. In particular, to achieve said object in the case of a transfer device of the type described at the beginning, it is therefore proposed according to the invention that, in the end position, in particular the working position, the at least one functional element is arranged partly in the process chamber and partly outside the process chamber. This means that even in the end position, in particular working position, part of the functional element is located outside the process chamber, which is advantageous because less material enters the process chamber. In addition, the transfer device may advantageously be formed outside the process chamber, as a result of which even less material can enter the process chamber. In total, therefore, by means of a transfer device according to the invention, particularly little material and thus potential contamination can be transferred into a process chamber, which in particular improves working in isolators in the pharmaceutical industry and increases product protection, and thus patient safety. In addition, the lower proportion of transferred material in the process chamber means that a unidirectional air flow (low-turbulence displacement flow) can be correspondingly less disturbed. In addition, a “first air contact”, i.e. a first contact of the air flow coming from a HEPA filter with a surface within the process chamber, may be possible over a larger area.

The process-relevant unidirectional air flow and the maintenance of the “first air contact” is thus only minimally affected.

For example, an end position may be characterizable as the end point of a transfer movement of the transfer device. A working position may be characterizable, for example, as a position in which the functional element carries out its intended function, for example a filling operation. Further, non-definitive examples of end positions may include further working positions in this sense or intermediate positions on a way to a working position in this sense.

Furthermore, in the case of a transfer device located outside the process chamber, it may be advantageous that its design (e.g. shape, weight and size) can be realized at least independently of the interior of the process chamber. Furthermore, it is possible to quickly and easily exchange a transfer device according to the invention between isolators without having to intervene in a process chamber.

This means that a transfer device can be optimally adapted to customer requirements.

However, a transfer device according to the invention may also be arranged in the process chamber. Space outside the process chamber can thus be saved, which is of advantage if, for example, preliminary processes have to be carried out outside the process chamber.

In general, a transfer device is designed to transfer a functional element, which is connected to an element carrier, into a process chamber. In this case, the transfer device itself can undertake a change in position in order to carry out the transfer of the functional element and/or the transfer device moves the element carrier from a starting position into an end position, in particular working position. A transfer device which can be changed in position may be any transfer device known to a person skilled in the art here. Alternatively or additionally, a transfer device can also change its length in order to transfer the element carrier into an end position, in particular a working position. The transfer movement may be manual or automated. This means that a transfer device can be designed in a variable and customer-oriented way.

A transfer device may additionally be designed to guide the at least one functional element out of the process chamber again. Such a transfer device is particularly advantageous for work in process chambers.

By means of a transfer device according to the invention, a process chamber can be formed in a relatively space-saving and cost-effective way, since the at least one functional element is transferable only partially, i.e. not completely, into the process chamber.

Furthermore, maintenance and repair work on the transfer device can be carried out more easily, since intervention in the process chamber can be avoided, which is particularly advantageous in isolators, clean rooms and containments.

The at least one functional element is interchangeably connected to an element carrier of the transfer device. This enables the functional element to be quickly mounted or removed for repair, maintenance or sterilization. An interchangeable functional element is thus particularly advantageous if a process chamber has to be kept free of contamination.

Furthermore, in the case of an interchangeable functional element, it is advantageous that process sequences can manage without lengthy interruptions, because even if the at least one functional element is not functional, it can be easily replaced by another functional element.

A transfer device according to the invention can have more than one element carrier, which element carriers can each be connected to a functional element. This advantageously enables a plurality of functional elements to be transferred into a process chamber, as a result of which processes can be adapted, expanded or designed more efficiently, which can further improve transfers and work in process chambers.

In an advantageous refinement, it may be provided that the at least one functional element is a dispensing element of a metering station. Thus, advantageously, a dispensing element of a metering station for filling containers, such as vials, cartridges, ampules or syringes, can be transferred into a process chamber of a clean room, containment or isolator.

In particular, the dispensing element may be in the form of a needle. Thus, even small containers can be filled precisely.

In an advantageous refinement, it may be provided that the at least one functional element is attached to the element carrier with a form fit and/or a force fit. This means that a functional element can be, for example, screwed, clamped or plugged onto the element carrier. A form-fitting and/or force-fitting attachment to the element carrier ensures a more robust connection of the functional element to the transfer device. This can improve transfer into the process chamber, since less contamination arises due to abrasion. Furthermore, a more robust connection can ensure less vibration at the transfer device and/or the at least one functional element, as a result of which both the transfer device and the functional element may be more durable.

In an advantageous refinement, it may be provided that the at least one functional element is connected to a supply line, in particular a medium line. Thus, liquid can be advantageously supplied to the at least one functional element.

A medium line is particularly advantageous if the functional element is designed as a dispensing element of a metering station. The medium line can be attached to the dispensing element in such a way that the medium line does not have to be transferred into the process chamber. It is advantageous that a medium line can be kept relatively short, and therefore undesired knotting and/or tangling of the medium line, in particular during a transfer, can be avoided.

A pneumatic supply line for the supply of gases, for example nitrogen, may also be connected to the functional element. Gases for certain processes may thus be advantageously supplied by the transfer device.

It can also be provided that a functional element, for example a needle or the aforementioned needle, is designed in such a way that the supply of at least one liquid and at least one gas to the process chamber can be advantageously realized.

In an advantageous refinement, it may be provided that the at least one functional element has at least one change of direction over its course. Thus, for optimal transfer into the working position, the at least one functional element can be adapted to the transfer device and/or to the configuration of the process chamber.

A change of direction may be here a bend in the functional element, for example a needle.

In particular, it may be provided here that the change of direction is part of a line and/or is formed by an extension. Thus, a functional element can be more precisely adapted to the transfer device and/or to the configuration of the process chamber.

A change of direction of a line should be understood as meaning a change of direction of that part of a line system which is located inside the functional element. Therefore, for example, a medium line inside a bent dispensing element may itself be bent. Thus, the line can be advantageously adapted to the shape of the dispensing element and protected by the latter.

A change of direction of a line therefore in particular does not mean a change of direction of the supply line caused by uncoordinated twisting (e.g. during the transfer of the functional element) of the supply line.

An extension may not only necessitate a change of direction of the functional element, but may also be designed to connect the functional element to the element carrier. An extension itself may have at least one change of direction, as a result of which the extension can be adapted specifically to a transfer device and/or to a functional element. This can be advantageous particularly for the connection between the transfer device and the functional element.

In an advantageous refinement, it may be provided that the at least one functional element protrudes in the end position, in particular the working position, through a transfer opening into the process chamber. In this case, the circumference of the transfer opening can be adapted to the circumference of the functional element such that even fewer contaminants enter the process chamber when the at least one functional element is transferred into the process chamber or is in the end position, in particular the working position.

It is particularly provided here that the transfer opening is arranged on a vertical and/or horizontal and/or oblique partition of the process chamber. The orientation of the transfer opening can be designed such that a transfer device can transfer a functional element into the process chamber in an energy-efficient manner. Therefore, for example, a transfer device which is positioned above a transfer opening in a horizontally or obliquely aligned partition can transfer the functional element downward into a process chamber by a short vertical movement.

In an advantageous refinement, it may be provided that the at least one functional element is transferable step by step into the process chamber. The advantage here is that the functional element can be optimally transferred into the process chamber. For example, it is thus possible that a functional element is advantageously transferred from a starting position via an assembly position and/or maintenance position and/or decontamination position into the process chamber. Thus, an optimal process sequence can also be initiated or carried out even outside the process chamber.

In an advantageous refinement, it may be provided that the at least one functional element is preferably pivotable on the element carrier into the process chamber. Pivotable may be understood as meaning, for example, a rotating movement about a fixed or moving pivot point. A transfer device which can pivot the at least one functional element into the process chamber can be designed in a space-saving manner, since the transfer device can be positioned very close or directly on a partition of the process chamber. A pivoting mechanism may also be designed energetically very favorably.

Furthermore, a transfer device can be directly connected to a transfer opening, as a result of which, advantageously, the transfer path of the functional element from the starting position into the end position, in particular the working position, can be shortened.

To achieve the stated object, further features according to the invention may be provided in which the element carrier has at least one connecting piece on which the at least one functional element is held. The connecting piece enables the functional element to be guided at a distance from a base plate of the element carrier. Thus, the connecting piece can be adapted to the dimensions of a functional element, as a result of which a transfer device may be usable in a variety of ways, which is advantageous for users.

In particular, the at least one functional element can be guided at an angle to the at least one connecting piece. Due to the angular guide, the at least one functional element can advantageously be positioned in a multiplicity of end positions, in particular working positions or intermediate positions.

Furthermore, an element carrier may also have a plurality of connecting pieces, as a result of which in particular large and/or heavy functional elements can be advantageously guided.

Alternatively or in addition, the element carrier is hinged at a distance from a partition, in particular the partition already mentioned. It is advantageous here that the element carrier can be very close to or directly on the partition, as a result of which a particularly short transfer path of the functional element into the process chamber is possible.

In an advantageous refinement, it may be provided that the transfer opening can be sealed by the movement of the element carrier into the end position, in particular the working position. Thus, the movement of the element carrier can advantageously be used in addition to the sealing of the transfer opening, as a result of which the transfer opening is opened only relatively shortly and thus the probability of contamination can be reduced even further.

In particular, the transfer opening can be sealed by the element carrier. Thus, the risk of contamination can be particularly greatly reduced, which is particularly advantageous in pharmaceutical environments, such as isolators, clean rooms or containments.

In an advantageous refinement, it may be provided that the element carrier has sealing elements. Sealing elements can be adapted to the surface of a partition, in particular the partition already mentioned, or to the shaping of a transfer opening, as a result of which sealing can be configured even more effectively.

Alternatively or additionally, sealing elements can be attached to the transfer opening and/or to the transfer device. Thus, sealing can be configured particularly effectively.

In an advantageous refinement, it may be provided that the transfer opening can be closed by the transfer device and/or by a closure cover when not in use. Not in use should be understood as meaning that a functional element is neither transferred nor positioned in the process chamber. In this case, a transfer device can seal a transfer opening, for example by a closure cover. The closure cover may be functionally and/or structurally coupled here to the transfer device. A transfer device can therefore be usable variably and configured to be customer-friendly, since it can also carry out other functions in addition to the transfer function.

In an advantageous refinement, it may be provided that there are at least two element carriers each with a functional element such that the functional elements are transferable independently of one another into the process chamber. Thus, each functional element is connected to the transfer device via a separate element carrier. An advantage of such a transfer device is the high degree of flexibility and productivity, since both structurally identical functional elements and different functional elements can be transferred into the process chamber. Thus, a customer-specific arrangement of functional elements can be realized, which improves transfers and work in process chambers. Process reliability can also be increased since arrangements of functional elements that have already been transferred can no longer be incorrectly manipulated.

Furthermore, the at least two functional elements can be transferred successively, i.e. offset temporally, into the process chamber, as a result of which the transfer of the at least two element carriers can be adapted to a respective process. This is particularly advantageous if the at least two functional elements can carry out different functions.

Successively may also mean that one element carrier of the at least two element carriers is not intended to be transferred at all into the end position, in particular the working position, during a process cycle. Thus, a transfer device can be used in a flexible and energy-saving manner, in particular in the case of filling devices. It is also advantageous, in particular in the pharmaceutical industry, if as little material as possible is transferred into a process chamber, in order to prevent contamination.

In particular, the at least two element carriers can be transferable pivotably in succession. This enables the at least two element carriers to be advantageously pivoted into the process chamber.

In an advantageous refinement, it may be provided that more than two element carriers, preferably eight or four element carriers, are arranged at a preferably regular distance from one another. Such a transfer device can be particularly advantageous for filling processes in which a plurality of dispensing elements, preferably four or eight dispensing elements, of a metering station are transferred into a process chamber. This makes filling processes particularly flexible, since the number and distance of the dispensing elements can be adapted to the type and orientation of the containers to be filled. It is also advantageous that the failure of one or more functional elements does not have to interrupt a process, in particular since the functional elements are interchangeably arranged on an element carrier and can thus be quickly interchanged.

In an advantageous refinement, it may be provided that the at least two functional elements are transferable, preferably independently of one another through separate transfer openings, into the process chamber. Independent transfer openings can be precisely adapted to the dimensions of a functional element, and therefore the overall area of all the transfer openings can be designed to be small. An advantageous feature of such a configuration may be that few, if any, contaminants, such as abrasion or microbes, enter the process chamber. A smaller exchange of air may also be achievable under different pressure conditions inside and outside the process chamber.

In an advantageous refinement, it may be provided that the at least one functional element, preferably a free section of the at least one functional element, is aligned in the end position, in particular the working position, in an oblique orientation and/or parallel to the partition. This means that the at least one functional element can be positioned exactly in the process chamber, and therefore process sequences can proceed without hindrance.

Alternatively or additionally, the functional elements can form an arrangement running along the partition. In this case, the arrangement may be designed such that the distances between the functional elements are adapted to the distances of the objects to be processed for an optimum carrying out of the process. For example, a plurality of needles for filling can be regularly spaced apart from one another such that regularly spaced containers can be filled simultaneously.

In an advantageous refinement, it may be provided that the process chamber is designed as part of an isolator. It may be provided here that the transfer device is formed on the partition between the process chamber and an outlet chamber or lock. The outlet chamber and/or lock may itself be designed as an isolator. This means that a transfer device can be used in particular in isolators, clean rooms or containments in the pharmaceutical industry or in other industrial sectors having aseptic environments. Alternatively or additionally, it may be provided here that the transfer device is formed on a bottom of the process chamber and/or on a bottom of an outlet chamber, for example the outlet chamber already mentioned, or in an environment, for example the environment already mentioned, of the process chamber. Thus, the transfer device may be set up outside the process chamber. Soiling of the process chamber, for example due to abrasion of a motorized or manual, electrical, electromagnetic, fluidic or mechanical drive of the transfer device, can be reduced.

In an advantageous refinement, it may be provided that a transfer is automated. This enables transfers of functional elements to be carried out in automated fashion, as a result of which processes can advantageously be accelerated. Such automated transfer by means of a transfer device makes it possible for pharmaceutical processes to be able to run in fully automated fashion.

In an advantageous refinement, it may be provided that, during the transfer, the functional element is simultaneously grippable by the transfer device and by a transport device. During the transfer at the transfer opening, the functional element can advantageously be held simultaneously by the transfer device and by a transport device, with one of the two devices mentioned being positioned in the outlet chamber and the second in the process chamber. Thus, transmission of contamination during the transfer can be reduced even further. Furthermore, the transfer device and the transport device can be arranged and functionally coordinated with each other in such a way that the transfer of the functional element into the process chamber proceeds without delay or disturbance by means of the simultaneous gripping. Thus, working in process chambers can be improved further.

The transfer device and the transport device may be structurally identical transfer devices, as a result of which maintenance and repairs can advantageously be carried out by the same technician, which can save on time and costs. Structurally identical transfer devices can also be better coordinated with one another, which is advantageous.

The transfer device and the transport device can be arranged in a space-saving manner, and therefore minimally little space is required in the outlet chamber and/or in the process chamber. Preferably, the transfer device and the transport device are not physically connected to each other, and therefore, for example, during maintenance work, only the transfer device to be worked on has to be dealt with without the other transfer device thereby being affected. Thus, a greater degree of flexibility of a transfer process can be achievable. A process line may also be less susceptible to malfunctioning because of the provided modularity of the transfer device and transport device.

In an advantageous refinement, it may be provided that, during the transfer, the functional element is arranged in the transfer opening. Thus, advantageously, parts of the functional element may be arranged in the outlet chamber and in the process chamber during the transfer. An advantage of this is that, during the transfer, the transfer opening, in particular when the transfer opening, as described above, is adapted to the dimensions of the functional element, can be sealed by the functional element to the extent that transmission of contaminants into the process chamber is reduced. This can also prevent parts of the transfer device and/or transport device from protruding through the transfer opening.

In an advantageous refinement, it may be provided that the process chamber is designed for receiving at least one container, in particular via a lock, and/or for processing same, in particular with a metering station. Thus, the at least one container can be protected from external environmental influences during processing, in particular filling, and/or the processing can be carried out with a reduced influence on an environment, for example by hazardous substances.

Alternatively or in addition, it may be provided that the process chamber is designed for processing at least one container, in particular using a metering station. It is advantageous here that the processing can be carried out with a reduced risk of contamination at the container.

In an advantageous refinement, it may be provided that the process chamber is subjected to a higher pressure and/or an air flow from the process chamber flows into an outlet chamber, for example the outlet chamber already mentioned, or into an environment and/or the process chamber meets a higher purity level than its environment and/or an adjacent outlet chamber. The invention is usable here with particular benefit, since it can be achieved in a simple way that as little soiling as possible is introduced into the process chamber by the functional elements. The invention is therefore also advantageously usable for systems with pressure cascades.

For example, the process chamber may be designed as a protected environment, in particular an isolator and/or an RABS (restricted-access barrier system, arrangement with an access-limiting or access-restricted barrier). For example, the process chamber may be an open or a closed RABS.

As an alternative or in addition, in order to achieve the stated object, the features of the further independent claim, which is directed to a method for transferring at least one functional element to a transfer opening for transferring same to a process chamber, are provided according to the invention. In particular, in order to achieve the stated object in the case of a method of the type described at the beginning, it is thus proposed according to the invention that, during the transfer, the transfer device and the transport device are separated by the transfer opening. By means of this method, a functional element can be transferred into a process chamber in a contamination-reducing manner, since the transfer device and the transport device remain in their respective chambers during the transfer. The transfer can be undertaken with even less contamination if the transfer opening, as described above, is adapted to the circumference of the functional element. Thus, an inventive method may be used to improve working in a process chamber, in particular when working in an isolator and very especially when filling pharmaceutical products.

Furthermore, transfer paths can be kept relatively short, if the transfer device and/or the transport device are positioned on the partition. Thus, a method according to the invention can be carried out quickly and energy-efficiently.

In an advantageous refinement of the method, it may be provided that, during the transfer, the functional element is positioned in the transfer opening. This means that, during the transfer, the transfer opening is occupied by the functional element. This makes it possible for admission of contaminants into the process chamber to be reduced even further, in particular in the case of transfer openings which, as described above, are adapted to the circumference of the functional element.

In an advantageous refinement of the method, it may be provided that, during the transfer, the functional element protrudes partly into an outlet chamber and partly into the process chamber. An advantage of this is that the functional element can be readjusted or modified without contamination passing through the transfer openings in the process. Thus, for example, a dispensing element that, during the transfer, still partly protrudes into the outlet chamber can be connected to a medium line in the outlet chamber.

In an advantageous refinement of the method, it may be provided that, during the transfer, the element carrier of the transfer device grips the functional element at a different gripping point from the element carrier of the transport device. In this case, the element carrier of the transfer device can preferably grip above and/or below the element carrier of the transport device, which is advantageous for the simultaneous gripping of the functional element during the transfer.

As an alternative or additionally, in order to achieve the stated object, the features of the further independent claim, which is directed to the use, are provided according to the invention. In particular, in order to achieve the stated object, in the case of the use of the type described at the beginning, it is thus proposed according to the invention that, in the case of a transfer device and/or in the case of a method, as described above or claimed below, after an at least partial transfer of the at least one functional element into the process chamber, the at least one functional element is preferably connectable or is connected to a supply line in the outlet chamber. Thus, assembly or removal of the at least one functional element with/from a supply line can take place outside the process chamber, as a result of which the process chamber can be kept free of contamination (abrasion, escaping liquid). This is particularly advantageous in isolators, containments and clean rooms.

### BRIEF DESCRIPTION OF THE DRAWINGS

The invention will now be described in more detail on the basis of exemplary embodiments, but is not restricted to these exemplary embodiments. Further exemplary embodiments arise from combining the features of individual or multiple claims with one another and/or with individual or multiple features of the exemplary embodiments.

In the figures:

FIG. 1 shows a side view of a transfer device according to the invention in an isolator,

FIG. 2 shows a side view of a transfer device according to the invention with a pivotable element carrier,

FIG. 3 shows a side view of a transfer device according to the invention, wherein the functional element is transferable by a horizontal partition,

FIG. 4 shows a side view of a transfer device according to the invention, wherein the functional element is transferable by an inclined partition,

FIG. 5 shows a side view of a transfer device according to the invention, wherein the functional element is transferable by an inclined partition,

FIG. 6 shows a side view of an alternative embodiment of a transfer device with a pivotable element carrier,

FIG. 7 shows a side view of a transfer device according to the invention with a connecting piece,

FIG. 8 shows a side view of a transfer device according to the invention, wherein an element carrier seals a transfer opening and a functional element is in the end position, in particular the working position,

FIG. 9 shows a side view of a transfer device according to the invention, wherein a closure cover seals a transfer opening,

FIG. 10 shows an isometric sectional view of a transfer device according to the invention with two element carriers,

FIG. 11 shows an isometric sectional view of a transfer device according to the invention with four element carriers,

FIG. 12 shows a partition of an isolator with eight needles in an end position, in particular working position,

FIG. 13 shows a transfer device in an isolator with a lock,

FIG. 14 shows an alternative transfer device in an isolator with a lock,

FIG. 15 shows a side view of a functional element in a first position,

FIG. 16 shows a side view of a functional element in the starting position,

FIG. 17 shows a side view of a functional element at the transfer opening,

FIG. 18 shows a side view of a functional element in the working position.

### DETAILED DESCRIPTION

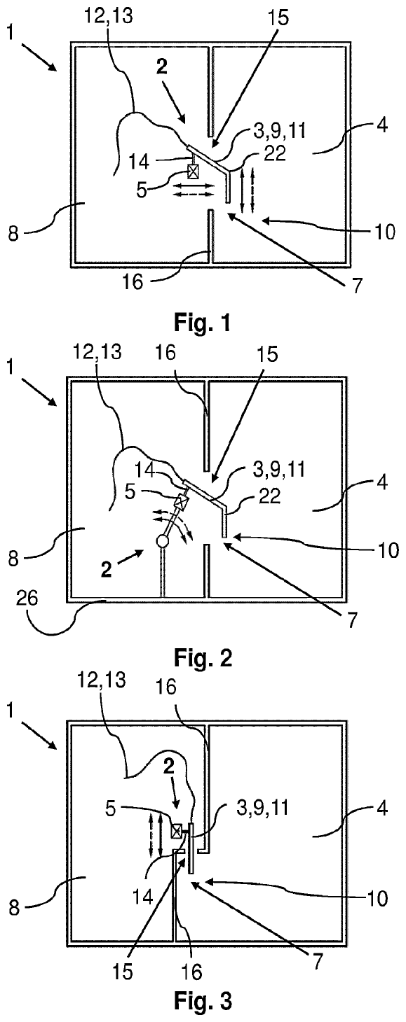

FIG. 1 shows an isolator 1 which is known in the pharmaceutical industry and has a transfer device 2 according to the invention. The transfer device 2 is located in an outlet chamber 8, which is separated from a process chamber 4 by a partition 16.

The functional element 3 shown in FIG. 1 is a dispensing element 9 in the form of a needle 11. The needle 11 is located within the process chamber 4 in a working position 7, as an end position of the transfer movement, functionally close to a metering station 10, not shown in more detail, at which, for example, vials, cartridges or ampules can be filled. Such a functional element 3, 9, 11 is also disclosed in the Figures below. However, any conceivable functional element 3 can be transferred by a transfer device 2 into a process chamber 4, as a result of which different processes can be carried out.

Furthermore, it can be seen in FIG. 1 that, in the working position 7, the needle 11 is arranged partly in the process chamber 4 and partly outside the process chamber 4. This arrangement of the needle 11 is illustrated, inter alia, in the alternative embodiments in FIGS. 2 to 6.

It can also be provided that the at least one functional element 3 has at least one change of direction over its course. Thus, the needles 11 illustrated in FIGS. 1, 2, 6, 8 and 12 to 14 are bent, as are the medium lines 13 located in the needles 11. A change of direction may also be realized by an extension 14 of the functional element 3. The extension 14 may be used, as illustrated for example in FIG. 1, for fastening the functional element 3, 9, 11 to the element carrier 5. In general, a change of direction may be advantageous if a functional element 3 has to be adapted to the alignment of a transfer opening 15 or to a process chamber 4. For example, a bent needle 11 may take up less space in the vertical extent than an elongate needle 11, as a result of which an outlet chamber 8 may be designed to be lower in a vertical orientation.

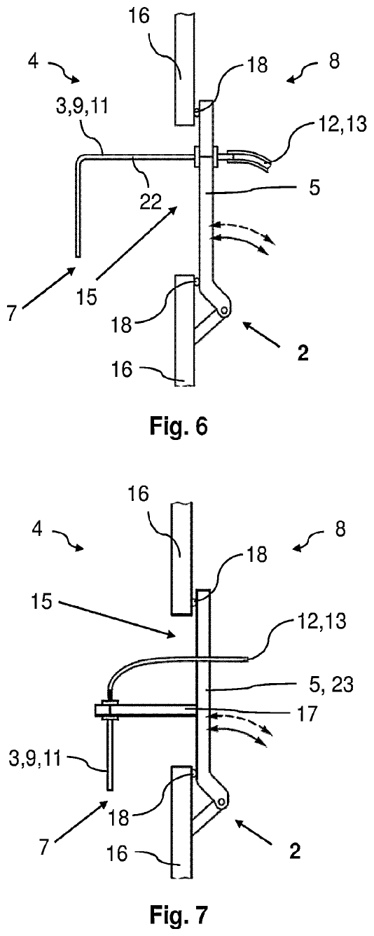

For the transfer into the process chamber 4, the at least one functional element 3 is arranged interchangeably on an element carrier 5 of the transfer device 2. In all of the Figures which disclose an element carrier 5, the element carrier 5 is connected to the functional element 3, 9, 11 with a form fit and/or a force fit. Thus, the functional element 3, 9, 11 can be screwed, clamped, or, as shown in FIGS. 6 and 7, plugged into the element carrier 5. FIG. 7 shows a functional element 3, 9, 11 which is even plugged into a connecting piece 17 of the element carrier 5, as a result of which the functional element 3, 9, 11 can be guided at an angle to the connecting piece 17 and guided at a distance from the base plate 23 of the element carrier 5. A connecting piece 17 can be adapted to the dimensions of one or more functional elements 3. Thus, for example, a connecting piece 17 may be designed to be greater or lesser in length depending on the dimensions of a functional element 3. In general, a connecting piece 17 may be adapted to a functional element 3 in respect of its shape and/or dimensions. Thus, a transfer device 2 may transfer different functional elements 3 and may be usable at different locations, which is advantageous for users.

Furthermore, the element carrier 5 may be permanently or interchangeably connected to the transfer device 2. Interchangeable element carriers 5 are advantageous in that a transfer device 2 can thereby transfer different functional elements 3 adapted to a respective element carrier 5.

The fluidic supply line 12 disclosed in FIG. 1 and the other Figures is a medium line 13. In general, a fluidic supply line 12 may be designed to either feed (for example, oil and/or cooling liquid) to the functional element 3 for self-propulsion and/or, for example, to fill containers 20, such as vials, cartridges, ampules or syringes, by means of a functional element 3, 9, 11 (medium line 13).

The supply line 12 may also be designed as a pneumatic supply line 12 for transporting gases.

The medium line 13 illustrated in FIG. 1 is connected to the functional element 3, 9, 11 within the outlet chamber 8 of the isolator 1. In the embodiment shown here, the assembly of the supply line 12 and the functional element 3, 9, 11 can take place either outside the isolator 1 or in the outlet chamber 8 of the isolator 1. Thus, contamination of the process chamber 4 during the assembly or removal (abrasion, escaping liquid) can be advantageously avoided.

By means of the transfer device 2, the at least one functional element 3, 9, 11 can be transferred steplessly (continuous arrow in all the Figures) or gradually (dashed arrow in all the Figures) into the process chamber 4. In this case, a transfer or a movement of the functional element 3, 9, 11 by a transfer device 2 may be in particular horizontal (FIGS. 1, 8, 13, 14 to 18), vertical (FIGS. 1, 3, 4, 10, 11) or rotating about a pivot point, i.e. pivotable (FIGS. 2, 5, 6, 7).

It is possible that the transfer devices 2 illustrated in the Figures transfer the functional elements 3, 9, 11 manually or automatically.

However, a transfer device 2 does not have to be restricted to one direction of movement, as in the paragraph described above. Rather, a transfer device 2 may carry out at least two directions of movement, as is illustrated, for example, in FIG. 1.

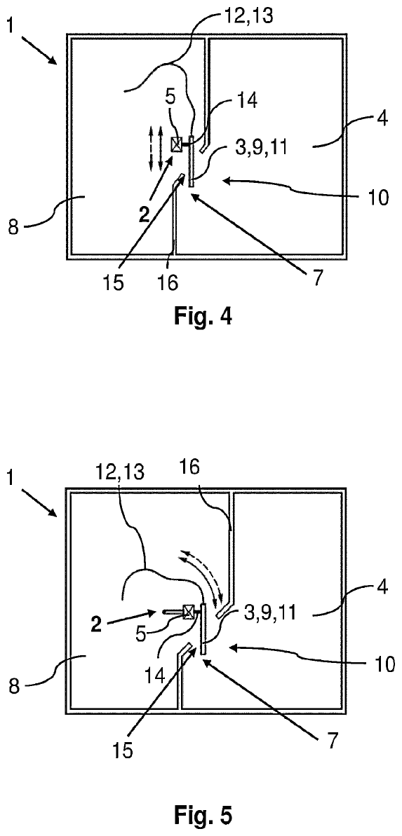

A transfer opening 15, through which the at least one functional element 3 is transferred, may be arranged preferably vertically (FIGS. 1, 2, 6, 7, 8, 9, 12 to 18) or horizontally (FIGS. 3, 10, 11) or obliquely (FIGS. 4 and 5), in or on a partition 16 of the process chamber 4. A transfer opening 15 may also be arranged on a bent partition 16 (not shown). Transfer openings 15 may be relatively small and precisely adapted to the outer circumference of the at least one functional element 3, as illustrated in the embodiments of FIGS. 10 to 12.

It is illustrated in FIGS. 6 to 8 that the transfer opening 15 can be sealed by the movement of the element carrier 5 into the working position 7 and into an end position of the transfer movement, as a result of which the process chamber 4 of the isolator 1 is particularly protected from contamination. Sealing and the associated protective effect is even more effective if the element carrier 5 has sealing elements 18 (FIGS. 6 and 7).

When the transfer device 2 is not in use, the transfer opening 15 may be sealed by a closure cover 24, as illustrated in the embodiment according to FIG. 9. The transfer opening 15 therein is closed by the closure cover 24 between the outlet chamber 8 and the process chamber 4 in such a way that advantageously no exchange whatsoever can take place between the two chambers 4, 8. The closure cover 24 may be functionally and/or structurally coupled to the transfer device 2.

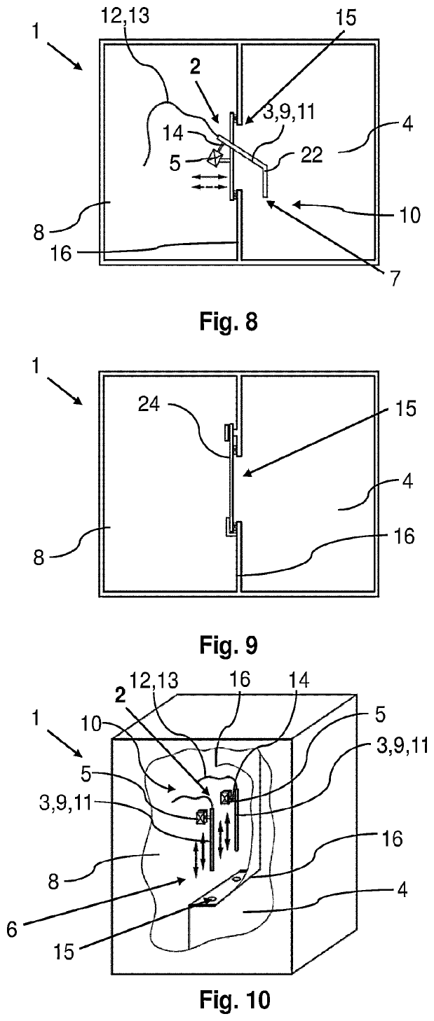

An element carrier 5 may be formed in different ways, and therefore an optimum interchangeable connection to the or a functional element 3 can take place. Furthermore, an element carrier 5 may have at least one change of direction, as illustrated, for example, in FIGS. 7 and 8. In the embodiments of FIGS. 7 and 8, the change of direction of the element carrier 5 ensures a distance of the element carrier 5 positioned at the partition 16 and below the transfer opening 15, as a result of which a pivotable transfer of the functional elements 3, 9, 11 is at least optimized.

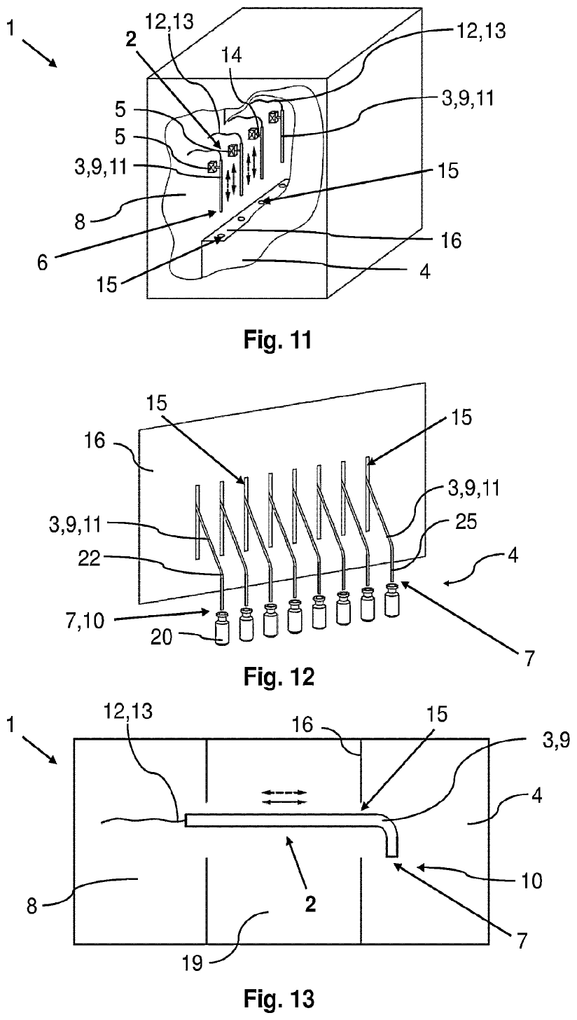

FIGS. 10 to 12 respectively disclose two, four and eight functional elements 3, 9, 11, which are each connected to an element carrier 5. The functional elements 3, 9, 11 of FIGS. 10 and 11 are located within the outlet chamber 8 in the starting position 6, whereas the functional elements 3, 9, 11 of the embodiment shown in FIG. 12 are in the working position 7.

The embodiment shown in FIG. 12 furthermore shows that free sections 25 of the functional elements 3, 9, 11 are aligned parallel to the partition 16 of an isolator 1 and form a regular arrangement along the partition 16. The regular arrangement is adapted here to the regular arrangement of the containers 20 at the metering station 10, and therefore the containers 20 can be filled by the functional elements 3, 9, 11 in the working position 7.

Furthermore, it is indicated in FIG. 12 that the functional elements 3, 9, 11 have a change of direction over their course, with the lines 22 located in the needles 11 also having a change of direction.

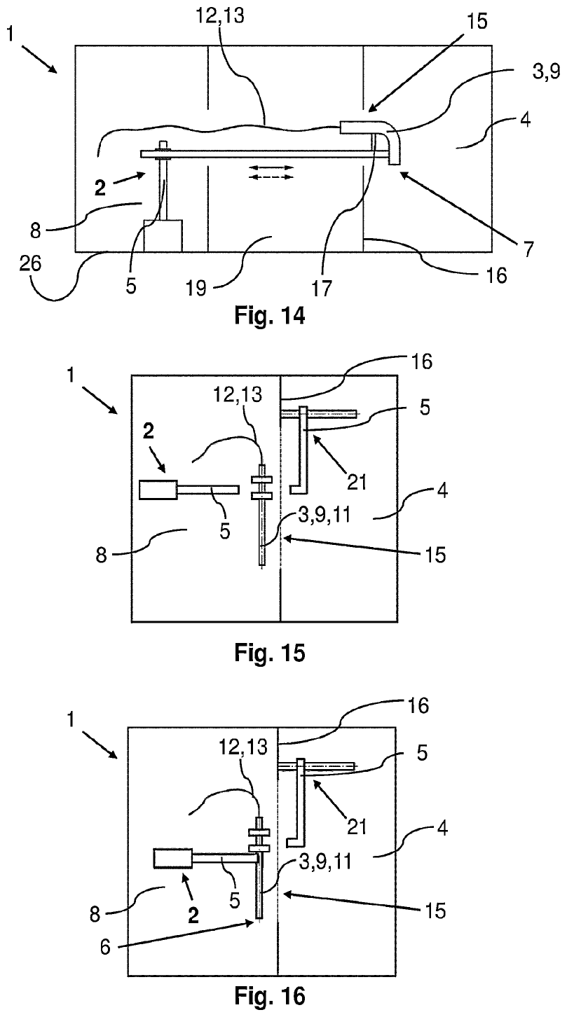

The embodiments of FIGS. 13 and 14 show isolators 1, in which the at least one functional element 3, 9 can be transferred by a transfer device 2 from an outlet chamber 8 via a lock 19 into a process chamber 4. Also in these embodiments, in the working position 7, the at least one functional element 3, 9 is arranged partly in the process chamber 4 and partly outside the process chamber 4. A lock 19 is particularly advantageous if the at least one functional element 3 is to be additionally sterilized.

A transfer device 2 may be arranged outside the process chamber 4 (e.g. FIGS. 1 to 18) or inside same (not shown). FIG. 14 indicates a length-variable transfer device 2, which can transfer the functional element 3, 9 from the outlet chamber 8 via a lock 19 to the process chamber 4.

The transfer device 2 shown in FIGS. 15 to 18 is arranged within the outlet chamber 8 of an isolator 1. A method according to the invention for transferring at least one functional element 3, 9, 11 into a process chamber 4 with such a transfer device 2 could proceed as follows.

The functional element 3, 9, 11 is assembled within the outlet chamber 8 with a fluidic supply line 12, 13 (FIG. 15). However, it is also possible that the assembly enters the outlet chamber 8 in completed form or is completed after transfer to the process chamber 4.

Subsequently, the functional element 3, 9, 11 is brought by a transfer device 2 to a starting position 6, which is located within the outlet chamber 8 (FIG. 16).

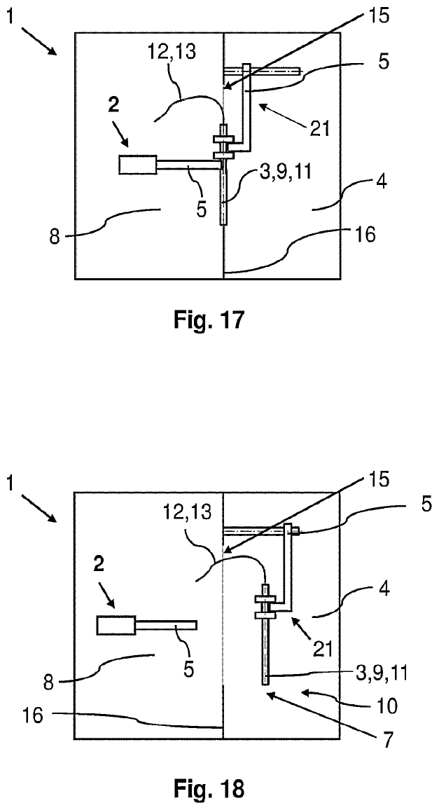

The functional element 3, 9, 11 is then moved into an end position and transferred there to the element carrier 5 of the transport device 21 (FIG. 17), and the transport device 21 transfers the functional element 3, 9, 11 via the transfer opening 15 into the process chamber 4 to a working position 7 (FIG. 18).

During the transfer (FIG. 17), the two element carriers 5 of the transfer device 2 and transport device 21 simultaneously grip the functional element 3, 9, 11, as a result of which the functional element 3, 9, 11 is transferred into the process chamber 4 without one of the element carriers 5 having to reach through the transfer opening 15. As a result, transmission of contaminants into the process chamber 4 is reduced.

During the transfer (FIG. 17), the functional element 3, 9, 11 is arranged in the transfer opening 15 and protrudes partly into the outlet chamber 8 and the process chamber 4. Since, in the case of the method shown here, the transfer opening 15 is adapted to the dimensions of the functional element 3, 9, 11 and to the supply line 12, 13 connected thereto, contamination of the process chamber 4 can be reduced to a minimum or even prevented.

After the transfer, the functional element 3, 9, 11 is moved by the transport device 21 to the working position 7 (FIG. 18).

The described method is illustrated by way of example by way of one functional element 3, 9, 11, but it may also be carried out with a plurality of functional elements, in particular with four or eight functional elements 3.

The described method is preferably carried out with a transport device 2, as described previously or claimed below. It is also possible that the transfer device 21 is designed as per a transport device 2, as described previously or claimed below.

In FIGS. 2 and 14, it is illustrated by way of example that the transfer device 2 is formed and supported on a bottom 26 of the environment of the process chamber 4, for example in the outlet chamber 8. In the other exemplary embodiments, this is realized in a similar manner, without being illustrated further. The transfer device 2 may also be formed on a bottom of the process chamber.

FIG. 12 shows processing of containers 20 by filling. For this purpose, the containers 20 have been introduced into the process chamber 4 from the outside, for example through a lock 19 (see FIG. 13), and kept ready in the process chamber 4.

In comparison to the outlet chamber 8, the process chamber 4, which can accommodate a multiplicity of containers 20 to be filled, has a higher pressure. Thus, an air flow can flow out of the process chamber 4 into the outlet chamber 8.

In this case or in another exemplary embodiment, the process chamber 4 may have a higher degree of purity or a higher purity level (for example, a higher-quality clean room class according to GMP Guideline Annex 1 or comparable specifications).

The invention generally proposes a transfer device 2 and a method for transferring at least one functional element 3 into a process chamber 4, wherein the at least one functional element 3 is interchangeably arranged on an element carrier 5 and the element carrier 5 is transferable from a starting position 6 into an end position, for example, a working position 7 or an intermediate position, wherein the at least one functional element 3 in the end position, for example the working position 7 or in the intermediate position, is arranged partly in the process chamber 4 and partly outside the process chamber 4. The invention is therefore particularly suitable for aseptic processes in the pharmaceutical industry, but is not limited to this sphere.

### LIST OF REFERENCE SIGNS

1 Isolator
2 Transfer device
3 Functional element
4 Process chamber
5 Element carrier
6 Starting position
7 Working position
8 Outlet chamber
9 Dispensing element
10 Metering station
11 Needle
12 Supply line
13 Medium line
14 Extension
15 Transfer opening
16 Partition
17 Connecting piece
18 Sealing elements
19 Lock
20 Container
21 Transport device
22 Line
23 Base plate
24 Closure cover
25 Free section of a functional element 3
26 Bottom

1. A transfer device (2) for transferring at least one functional element (3) into a process chamber (4), the transfer device comprising:
an element carrier (5) on which the at least one functional element (3) is arranged interchangeably, and the element carrier (5) is transferable from a starting position (6) into an end position, which is a working position (7), and in the working position (7), the at least one functional element (3) is arranged partly in the process chamber (4) and partly outside the process chamber (4).

2. The transfer device (2) as claimed in claim 1, wherein the at least one functional element (3) is a dispensing element (9) of a metering station (10), and the dispensing element (9) comprises a needle (11).

3. The transfer device (2) as claimed in claim 1, wherein the at least one functional element (3) is attached to the element carrier (5) with at least one of a form fit or a force fit.

4. The transfer device (2) as claimed in claim 1, wherein the at least one functional element (3) is connected to a supply line (12).

5. The transfer device (2) as claimed in claim 1, wherein the at least one functional element (3) has at least one change of direction over a course thereof, the change of direction being at least one of part of the line (22) or formed by an extension (14).

6. The transfer device (2) as claimed in claim 1, wherein the at least one functional element (3) protrudes in the end position through a transfer opening (15) into the process chamber (4), the transfer opening (15) being arranged on at least one of a vertical, horizontal, or oblique partition (16) of the process chamber (4).

7. The transfer device (2) as claimed in claim 1, wherein the at least one functional element (3) is transferable step by step into the process chamber (4).

8. The transfer device (2) according to claim 1, wherein the at least one functional element (3) is pivotable on the element carrier (5) into the process chamber (4).

9. A transfer device (2) for transferring at least one functional element (3) into a process chamber (4), the transfer device comprising:
an element carrier (5) on which the at least one functional element (3) is arranged interchangeably, and the element carrier (5) is transferable from a starting position (6) into an end position, which is a working position (7), and at least one of a) the element carrier (5) has at least one connecting piece (17) on which the at least one functional element (3) is held, with the at least one functional element (3) being guidable at an angle to the at least one connecting piece (17), or b) the element carrier (5) is hinged at a distance from a partition (16) of the process chamber (4) through which a transfer opening (15) into the process chamber (4) is located.

10. The transfer device (2) as claimed in claim 6, wherein the transfer opening (15) is sealable by the movement of the element carrier (5) into the end position.

11. The transfer device (2) as claimed in claim 6, wherein at least one of the element carrier (5) has sealing elements (18) or sealing elements (18) are attached to at least one of the transfer opening (15) or the transfer device (2).

12. The transfer device (2) as claimed in claim 6, wherein the transfer opening (15) is closeable by at least one of the transfer device (2) or a closure cover (24) when not in use.

13. The transfer device (2) according to claim 1, wherein there are at least two element carriers (5) each with at least a respective one of the functional elements (3) such that the functional elements (3) are transferable independently of one another into the process chamber (4).

14. The transfer device (2) as claimed in claim 15, wherein there are more than two element carriers (5) arranged at a distance from one another.

15. The transfer device (2) as claimed in claim 13, wherein the at least two functional elements (3) are independently of one another through separate transfer openings (15) into the process chamber (4).

16. The transfer device (2) as claimed in claim 6, wherein at least one of a) the at least one functional element (3) is aligned at least in a free section (25) in the end position in an oblique orientation or parallel to the partition (16), or the at least one functional element includes more than one of the functional elements (3) that form an arrangement running along the partition (16).

17. The transfer device (2) as claimed in claim 1, wherein at least one of the process chamber (4) is designed as part of an isolator (1) or in that the transfer device (2) is formed on a partition (16) between the process chamber (4) and at least one of an outlet chamber (8), a lock (19), a bottom (26) of the process chamber (4), or a or the outlet chamber (8).

18. The transfer device (2) as claimed in claim 1, wherein a transfer using the transfer device is automated.

19. The transfer device (2) according to claim 1, wherein, during the transfer, the functional element (3) is simultaneously grippable by the transfer device (2) and by a transport device (21) arranged in the process chamber (4).

20. The transfer device (2) as claimed in claim 19, wherein, during the transfer, the functional element (3) is arranged in a transfer opening (15) into the process chamber (4).

21. The transfer device (2) as claimed in claim 1, wherein the process chamber (4) is designed for at least one of processing or receiving at least one container (20).

22. The transfer device (2) as claimed in claim 1, wherein at least one of the process chamber (4) is subjected to a higher pressure, an air flow from the process chamber (4) flows into an outlet chamber (8) or an environment, or the process chamber (4) meets a higher purity level than at least one of a surrounding environment or an adjacent outlet chamber (8).

23. A method for transferring at least one functional element (3) to a transfer opening (15) for transferring said at least one functional element to a process chamber (4), the method comprising:
transferring the functional element (3) by a transfer device (2) to the transfer opening (15);
receiving the functional element (3) in the process chamber (4) from the transport device (21); and
during the transfer, the transfer device (2) and the transport device (21) are separated by the transfer opening (15).

24. The method as claimed in claim 23, further comprising positioning the functional element (3) in the transfer opening (15) during the transfer.

25. The method as claimed in claim 23, wherein, during the transfer, the functional element (3) protrudes partly into an outlet chamber (8) and partly into the process chamber (4).

26. The method as claimed in claim 23, further comprising, during the transfer, the element carrier (5) of the transfer device (2) gripping the functional element (3) at a different gripping point from the element carrier (5) of the transport device (21).

27. The method as claimed in claim 23, further comprising introducing, at least one container (20) into the process chamber (4) or making the at least one container available in the process chamber (4).

28. (canceled)
